(19) United States
(12) Patent Application Publication
(10) Pub. No.: US 2003/0136275 A1
(43) Pub. Date: Jul. 24, 2003

(54) Method of cooling ingesta

(76) Inventors: Sadaaki Yasuda, Tokyo (JP); Hiroaki Nakamura, Asaka-shi (JP)

Correspondence Address: BACHMAN & LAPOINTE, P.C., 900 CHAPEL STREET, SUITE 1201, NEW HAVEN, CT, 06510, US

(21) Appl. No.: 10/313,527

(22) Filed: Dec. 6, 2002

(30) Foreign Application Priority Data
Jan. 22, 2002 (JP) 2002-012933
Feb. 6, 2002 (JP) 2002-029022

(51) Int. Cl. A23B 4/08

(52) U.S. Cl. 99/517

(57) ABSTRACT

A method of cooling ingesta includes the following steps: i) jetting an air from a port defined in a nozzle; ii) insufflating the jetted air directly to the ingesta; and iii) cooling the ingesta with the air. A method of cooling a food includes the following steps: i) putting the food on a plate having a ventilation; ii) passing the air in the food, by absorbing the air with a vacuum device disposed below the plate; and iii) cooling the food from an inner part thereof. Another method of cooling the food includes the following steps: i) putting the food on the plate having the ventilation; ii) passing the air in the food, by: insufflating the air from the nozzle to an upper part of the food and absorbing the air with the vacuum device disposed below the plate; and iii) cooling the food from the inner part thereof.

### BACKGROUND OF THE INVENTION

1. Field of the Invention

The present invention relates to a method of cooling ingesta.

Especially, the present invention relates to the method which is preferred for cooling a hot boiled rice to a predetermined temperature by a vacuum method or a ventilation method. The boiled rice includes those which are molded into various shapes (hereinafter referred to as “boiled molded rice”) before cooling.

2. Description of the Related Art

What is called a packed lunch sold at a convenience store and the like, or delivered to home, company and the like is generally made in such sequential steps that the boiled rice is at first cooled to a predetermined temperature such as in a range from 20° C. to 25° C., and then is packed in a pack, a box and the like.

A. Hereinafter described is concerning the boiled rice without being molded into a certain shape:

Opposite to the above general steps, recently the boiled rice is, as the case may be, made in such sequential steps that the boiled rice is at first packed in the pack, the box and the like, and then is cooled to the predetermined temperature.

Conventionally, a method for cooling the packed boiled rice is carried out in the following steps:

1. Feed the pack (packing therein the boiled rice) in a cooling device such as a ventilating duct and the like where a cooling air is circulating.

2. Expose (leave) the packed boiled rice in the cooling device for cooling.

The conventional method having the above steps, however, may bring about the following points since the boiled rice is packed when cooled:

1) The cooling device becomes large in dimension. In addition, the cooling air is not concentrated at the boiled rice, thus lowering cooling effect and efficiency.

2) The cooling air cools an inner part of the packed boiled rice less rapidly, compared with a surface of the packed boiled rice. Cooling the inner part of the packed boiled rice to the predetermined temperature, however, may cause an excessive cooling of the surface of the packed boiled rice.

3) The cooling air applied to the surface of the packed boiled rice may also be applied to a surface of the pack, resulting in dew formed on an inside wall of the pack.

B. Hereinafter described is concerning the boiled molded rice which is molded into a certain shape:

Molding the boiled rice which are cooled down in advance by the vacuum method or the ventilation method may cause the following points:

1) Securing moldability of the boiled rice after the cooling is supposed to be in need of an oil added to the rice during boiling.

2) Producing the boiled molded rice after cooling is supposed to spend a long time (less than or equal to about 9 hours). Preventing rotted rice in the long time requires injection of pH regulator to the rice during boiling, resulting in degradation in taste or causing odor.

3) Especially, cooling the boiled rice by the vacuum method may congest grains of the boiled rice during cooling. The thus cooled boiled rice may lead to breakage of the surface of rice grains during loosening of the rice grains, resulting in discouraged food eating feel and texture (or mouth feel) as well as visual deterioration.

### BRIEF SUMMARY OF THE INVENTION

It is an object of the present invention to provide a method of cooling a boiled rice by concentrating a cooling air to the boiled rice which is packed in a pack, a box and the like, thus allowing a cooling device small in dimension and increasing cooling effect and efficiency.

It is another object of the present invention to provide a method of cooling the boiled rice, by molding the boiled rice before cooling or by putting the boiled rice in a mold and the like during cooling.

According to a first aspect of the present invention, there is provided a method of cooling ingesta. The method comprises the following steps:

i) jetting an air from a port defined in a nozzle;

ii) insufflating the jetted air directly to the ingesta; and

iii) cooling the ingesta with the air.

According to a second aspect of the present invention, there is provided a method of cooling a food. The method comprises the following steps:

i) putting the food on a plate having a ventilation;

ii) passing an air in the food, by absorbing the air with a vacuum device disposed below the plate; and

iii) cooling the food from an inner part thereof.

According to a third aspect of the present invention, there is provided a method of cooling a food. The method comprises the following steps:

i) putting the food on a plate having a ventilation;

ii) passing an air in the food, by:

insufflating the air from a nozzle to an upper part of the food and

absorbing the air with a vacuum device disposed below the plate; and

iii) cooling the food from an inner part thereof.

The other objects and features of the present invention will become understood from the following description with reference to the accompanying drawings.

### BRIEF DESCRIPTION OF THE SEVERAL VIEWS OF THE DRAWINGS

FIG. 1 shows an overall view of a method for cooling a boiled rice 2;

FIG. 2 shows a cross section of a nozzle 3;

FIG. 3 (FIG. 3A, FIG. 3B, FIG. 3C and FIG. 3D) shows the method of cooling the boiled rice 2 step by step, according to a first embodiment of the present invention;

FIG. 4 shows a flow chart of the steps in FIG. 3;

FIG. 5 (FIG. 5A, FIG. 5B, FIG. 5C and FIG. 5D) shows the method of cooling the boiled rice 2 step by step, according to a second embodiment of the present invention;

FIG. 6 shows a flow chart of the steps in FIG. 5;

FIG. 7 shows the method of cooling the boiled rice 2, according to a third embodiment of the present invention;

FIG. 8 shows an overall view of a method of cooling a boiled molded rice 11, according to a fourth embodiment of the present invention;

FIG. 9 shows the overall view of the method of cooling the boiled molded rice 11, according to a fifth embodiment of the present invention;

FIG. 10 shows the overall view of the method of cooling the boiled molded rice 11, according to a sixth embodiment of the present invention; and

FIG. 11 shows the overall view of the method of cooling the boiled molded rice 11, according to a seventh embodiment of the present invention.

### DETAILED DESCRIPTION OF THE EMBODIMENT

In the following, various embodiments of the present invention will be described in detail with reference to the accompanying drawings.

For ease of understanding, the following description will contain various directional terms, such as, left, right, upper, lower and the like. However, such terms are to be understood with respect to only a drawing or drawings on which the corresponding part of element is illustrated.

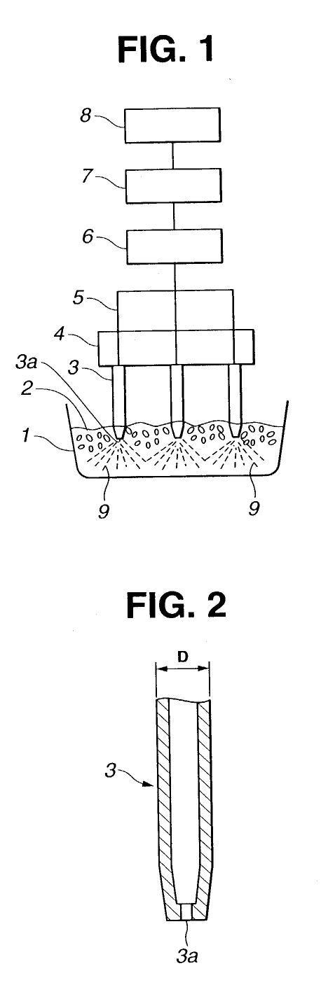

As is seen in FIG. 1 to FIG. 7, there are provided methods of cooling a boiled rice 2 having a temperature in a range from 55° C. to 90° C., to a temperature in a range from 20° C. to 25° C. Herein, the cooling is to be carried out after packing the boiled rice 2 in a pack 1.

FIG. 1 shows a state in which the boiled rice 2 is packed in the pack 1 such as a lunch box, and a nozzle 3 is sunk in the boiled rice 2.

As is seen in FIG. 2, the nozzle 3 is shaped substantially into a tube having an outer diameter smaller than or equal to about 5 mm. The nozzle 3 has a head end (lower in FIG. 2) which is formed with an air jet port 3a having a diameter smaller than or equal to about 3 mm.

Defining the outer diameter of the nozzle 3 smaller than or equal to about 5 mm is for eliminating a remarkable trace which may be caused when the nozzle 3 is sunk in the boiled rice 2, while defining the diameter of the air jet port 3a smaller than or equal to about 3 mm is for preventing the air jet port 3a from being clogged with grains of the boiled rice 2.

The nozzle 3 is mounted to a lift 4. Moreover, the nozzle 3 connects sequentially to a sterilizer 6, a cooling device 7 and an air compressor 8, by way of an air tube 5.

An air fed from the air compressor 8 is cooled in a range from 10° C. to 20° C. in the cooling device 7, and then is sterilized in the sterilizer 6. Thereafter, the air is fed from the air jet port 3a at wind pressure of 0.05 MPa to 0.35 MPa and at a flow rate of 300 mm³/sec to 1500 mm³/sec.

The wind pressure defined from 0.05 MPa to 0.35 MPa and the flow rate defined from 300 mm³/sec to 1500 mm³/sec are preferred for effectively and efficiently cooling the boiled rice 2 by diffusing the air (jetted from the air jet port 3a of the nozzle 3) in the boiled rice 2.

Described hereinafter is the method of cooling the boiled rice 2 step by step, according to a first embodiment of the present invention.

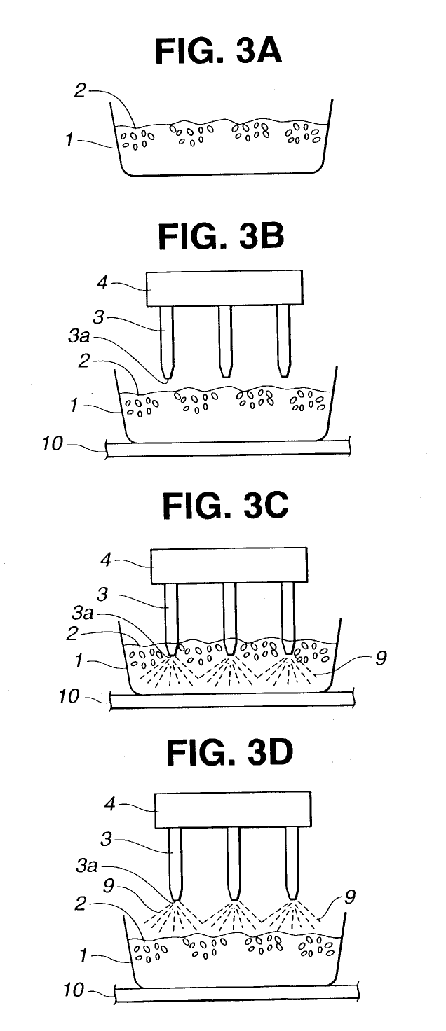

1. As is seen in FIG. 3A, pack (load) the boiled rice 2 in the pack 1.

2. As is seen in FIG. 3B, convey the pack 1 to below the nozzle 3 by means of a belt conveyer 10.

3. As is seen in FIG. 3C, move down the nozzle 3 substantially vertically by means of the lift 4, to such an extent that the head end (formed with the air jet port 3a) of the nozzle 3 can be sunk in the boiled rice 2 in a range from 5 mm to 15 mm from a surface of the boiled rice 2. Then, jet a cooling air 9 from the air jet port 3a to an inner part of the boiled rice 2. The cooling air 9 jetted into the boiled rice 2 can cool the boiled rice 2 disposed below the air jet port 3a.

4. As is seen in FIG. 3D, lift the nozzle 3 by means of the lift 4. Then, jet the cooling air 9 from the air jet port 3a continuously for cooling the surface of the boiled rice 2, thus cooling the entire part of the boiled rice 2.

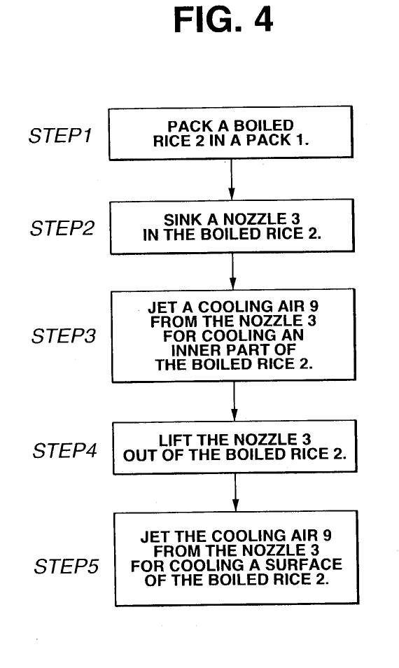

FIG. 4 shows a flow chart of the method of cooling the boiled rice 2, according to the first embodiment of the present invention.

Described hereinafter is the method of cooling the boiled rice 2 step by step, according to a second embodiment of the present invention.

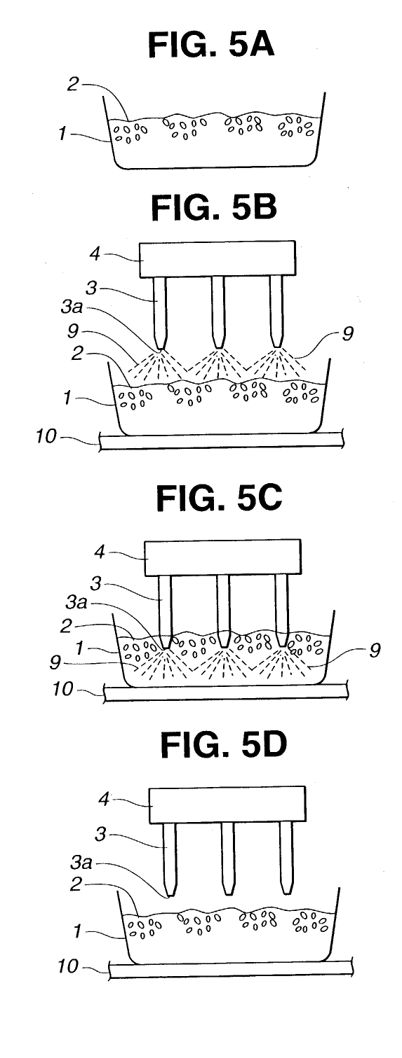

1. As is seen in FIG. 5A, pack (load) the boiled rice 2 in the pack 1.

2. As is seen in FIG. 5B, convey the pack 1 to below the nozzle 3 by means of the belt conveyer 10. Then, jet the cooling air 9 from the air jet port 3a to the surface of the boiled rice 2 for cooling. Thereafter, move down the nozzle 3 substantially vertically by means of the lift 4, with the cooling air 9 jetted.

3. As is seen in FIG. 5C, jet the cooling air 9 to the inner part of the boiled rice by sinking the head end of nozzle 3 in the range from 5 mm to 15 mm from the surface of the boiled rice 2, so as to cool the boiled rice 2 disposed below the air jet port 3a. After cooling the entire part of the boiled rice 2, move to the subsequent step.

4. As is seen in FIG. 5D, lift the nozzle 3 out of the boiled rice 2 by means of the lift 4.

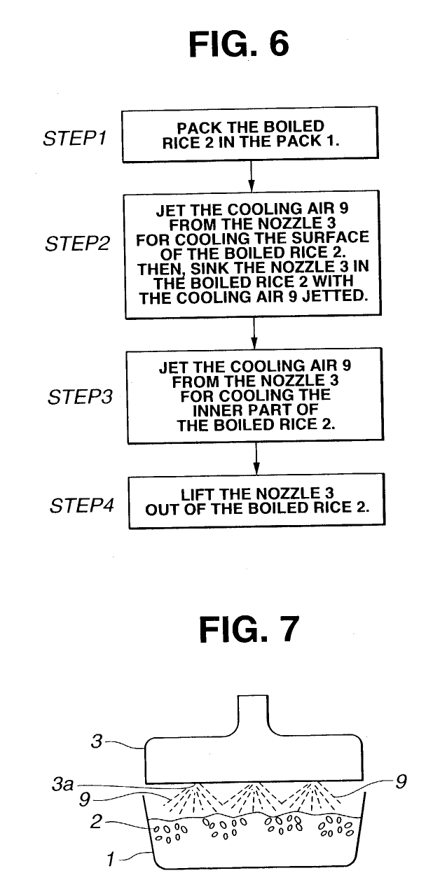

FIG. 6 shows a flow chart of the method of cooling the boiled rice 2, according to the second embodiment of the present invention.

The method of cooling the boiled rice 2 according to the second embodiment allows the nozzle 3 to be sunk in the boiled rice 2, with the cooling air 9 jetted from the air jet port 3a. In other words, such two operations, that is, jetting and sinking, can further securely prevent the air jet port 3a from being clogged with the grains of the boiled rice 2.

Described hereinafter is the method of cooling the boiled rice 2, according to a third embodiment of the present invention.

As is seen in FIG. 7, the air jet port 3a of the nozzle 3 is not sunk in the boiled rice 2 for cooling the boiled rice 2 in the pack 1.

The air jet port 3a of the nozzle 3 is disposed as in the vicinity of the boiled rice 2 as possible. Then, the cooling air 9 jetted from the air jet port 3a is insufflated directly to the boiled rice 2.

According to the third embodiment, the nozzle 3 not sunk in the boiled rice 2 can contribute to prevention of trace of the nozzle 3, which trace may be observed by the methods according to the first embodiment and the second embodiment. The above trace-free method according to the third embodiment allows binding of a plurality of the nozzles 3, which is great in dimension and shaped substantially into a curtain.

According to the third embodiment, the plurality of the nozzles 3 not sunk in the boiled rice 2 can contribute to prevention of the air jet port 3a from being clogged with the grains of the boiled rice 2.

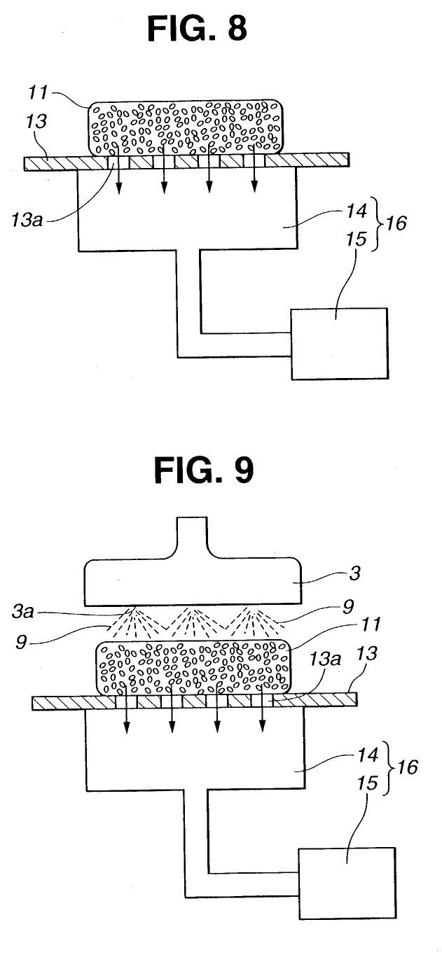

As is seen in FIG. 8 to FIG. 11, there are provided methods of cooling the boiled rice 2 molded into a certain shape (hereinafter referred to as “boiled molded rice 11”) and having a temperature in a range from 55° C. to 90°, to a temperature in a range from 18° C. to 25° C. Herein, the cooling is to be carried out after molding the boiled rice 2 into the boiled molded rice 11.

Described hereinafter is the method of cooling the boiled molded rice 11, according to a fourth embodiment of the present invention.

As is seen in FIG. 8, the boiled molded rice 11 shaped into a Japanese food “onigiri” is put on a punch plate 13 (having ventilation) in a cooling chamber. A vacuum device 16 disposed below the punch plate 13 can absorb the cooling air 9. Allowing the cooling air 9 to pass through the boiled molded rice 11 cools the boiled molded rice 11 from the inner part thereof. Described below is a briefing of the Japanese food onigiri:

The onigiri is conventionally made by pressing it with palms of both hands. Of course, such cooking method is alive now as well as automation. A typical dictionary term of onigiri is “rice ball.” The onigiri generally tastes salty, and is sometimes covered partly or entirely with a dried seaweed and the like.

The punch plate 13 is formed with a plurality of small holes 13a which are disposed inside an outer periphery of the boiled molded rice 11. More specifically, the small hole 13a that is disposed outermost in the punch plate 13 defines an outer periphery that is farthest from a center of the punch plate 13. The farthest outer periphery of the outermost small hole 13a is disposed inside the outer periphery of the boiled molded rice 11 by smaller than or equal to 5 mm.

Below the punch plate 13, the vacuum device 16 is fitted with a vacuum chamber 14 and a blow fan 15 (the latter of which is otherwise referred to as a vacuum pump or a compressor). Applying a vacuum pressure to the vacuum chamber 14 by means of the blow fan 15 allows the cooling air 9 in the cooling chamber to pass through the boiled molded rice 11 and the small holes 13a of the punch plate 13. Then, the cooling air 9 can be absorbed by the vacuum chamber 14. At this point in time, the boiled molded rice 11 in the shape of the Japanese food onigiri can be effectively and efficiently cooled with the cooling air 9 passing through the boiled molded rice 11.

Described hereinafter is the method of cooling the boiled molded rice 11, according to a fifth embodiment of the present invention.

As is seen in FIG. 9, the boiled molded rice 11 shaped into the Japanese food onigiri is put on the punch plate 13 (having ventilation) in the cooling chamber. The nozzle 3 is used for insufflating the cooling air 9 to an upper surface of the boiled molded rice 11. Substantially simultaneously with this, the vacuum device 16 disposed below the punch plate 13 can absorb the cooling air 9 jetted from the nozzle 3. Thereby, the method described above can cool effectively and efficiently the boiled molded rice 2 from the inner part thereof.

Described hereinafter is the method of cooling the boiled molded rice 11, according to a sixth embodiment of the present invention.

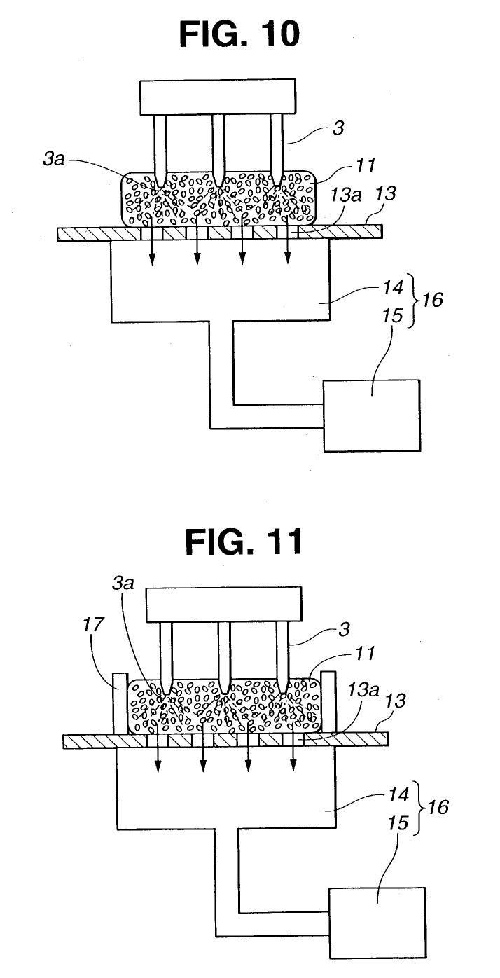

As is seen in FIG. 10, the head end (formed with the air jet port 3a) of the nozzle 3 is sunk in the boiled molded rice 11 shaped into the Japanese food onigiri, so as to jet the cooling air 9 directly to the inner part of the boiled molded rice 2. The method according to the sixth embodiment can increase effect and efficiency of cooling the boiled molded rice 11. The other parts according to the sixth embodiment in FIG. 10 are substantially the same as those according to the fifth embodiment in FIG. 9. Therefore, repeated explanation is to be omitted.

Described hereinafter is the method of cooling the boiled molded rice 11, according to a seventh embodiment of the present invention.

As is seen in FIG. 11, the boiled molded rice 11 is put inside a mold 17 having a through hole extending from an upper end to a lower end, and is cooled on the punch plate 13. The other parts according to the seventh embodiment in FIG. 11 are substantially the same as those according to the sixth embodiment in FIG. 10. Therefore, repeated explanation is to be omitted.

Although the present invention has been described above by reference to certain embodiments, the present invention is not limited to the embodiments described above. Modifications and variations of the embodiments described above will occur to those skilled in the art, in light of the above teachings.

More specifically, the methods according to the fourth embodiment in FIG. 8, the fifth embodiment in FIG. 9, the sixth embodiment in FIG. 10 and the seventh embodiment in FIG. 11 can cool the “boiled molded rice 11 (shaped into the Japanese food onigiri).” The fourth embodiment, the fifth embodiment, the sixth embodiment and the seventh embodiment are, however, not limited to the above. The methods according to the fourth embodiment, the fifth embodiment, the sixth embodiment and the seventh embodiment can also be used for cooling the boiled rice 2 (packed in the pack 1) which is disclosed in FIG. 3, FIG. 5 and FIG. 7, if each of the packs 1 according to the first embodiment in FIG. 3, the pack 1 according to the second embodiment in FIG. 5 and the pack 1 according to the third embodiment in FIG. 7 has ventilation. In this case, the pack 1 is free from dimensional limitation, excluding when using the method according to the seventh embodiment in FIG. 11. Moreover, the pack 1 can be replaced with a pad which is used for conveying the boiled rice 2 from a kettle for cooling the boiled rice 2.

Moreover, the methods according to the fourth embodiment in FIG. 8, the fifth embodiment in FIG. 9, the sixth embodiment in FIG. 10 and the seventh embodiment in FIG. 11 can cool from the inner part of the boiled molded rice 11 (shaped into the Japanese food onigiri), by allowing the cooling air 9 (which is absorbed by means of the vacuum device 16) to pass through the boiled molded rice 11. The fourth embodiment, the fifth embodiment, the sixth embodiment and the seventh embodiment are, however, not limited to the above. The vacuum device 16 can be replaced with an air blower disposed below the punch plate 13 for allowing the cooling air 9 to pass through the boiled molded rice 11 for cooling from the inner part of the boiled molded rice 11.

The entire contents of basic Japanese Patent Application No. P2002-012933 (filed on Jan. 22, 2002 in Japan) and Japanese Patent Application No. P2002-029022 (filed on Feb. 6, 2002 in Japan) are incorporated herein by reference, in order to take some protection against mis-translation or omitted portions.

The scope of the present invention is defined with reference to the following claims.

What is claimed is:

1. A method of cooling ingesta, comprising the following steps:
i) jetting an air from a port defined in a nozzle;
ii) insufflating the jetted air directly to the ingesta; and
iii) cooling the ingesta with the air.

2. The method of cooling the ingesta as claimed in claim 1, wherein
the method further comprises a step of sinking the nozzle in the ingesta to thereby allow the air to be insufflated from the port to the ingesta for cooling the ingesta from an inner part thereof.

3. The method of cooling the ingesta as claimed in claim 2, wherein
the ingesta is a boiled rice.

4. The method of cooling the ingesta as claimed in claim 3, wherein
the nozzle is shaped substantially into a tube having an outer diameter smaller than or equal to 5 mm.

5. The method of cooling the ingesta as claimed in claim 2, wherein
the port is formed at a head end of the nozzle.

6. The method of cooling the ingesta as claimed in claim 5, wherein
the port of the nozzle has a diameter smaller than or equal to 3 mm.

7. The method of cooling the ingesta as claimed in claim 6, wherein
the air jetted from the port of the nozzle has a jet pressure in a range from 0.05 MPa to 0.35 MPa.

8. The method of cooling the ingesta as claimed in claim 2, wherein
the air is sterilized with a sterilizer before the air is jetted from the port of the nozzle.

9. The method of cooling the ingesta as claimed in claim 7, wherein
the air jetted from the port of the nozzle is fed at a flow rate in a range from 300 mm³/sec to 1500 mm³/sec.

10. The method of cooling the ingesta as claimed in claim 5, wherein
the nozzle is sunk in the ingesta with a lift,
the head end formed with the port of the nozzle is sunk from a surface of the ingesta in a range from 5 mm to 15 mm, and
the ingesta is cooled to a temperature in a range from 20° C. to 25° C. after the cooling step.

11. A method of cooling a food, comprising the following steps:
i) putting the food on a plate having a ventilation;
ii) passing an air in the food, by absorbing the air with a vacuum device disposed below the plate; and
iii) cooling the food from an inner part thereof.

12. The method of cooling the food as claimed in claim 11, wherein
the food is a boiled rice.

13. The method of cooling the food as claimed in claim 12, wherein
the boiled rice is a boiled molded rice.

14. The method of cooling the food as claimed in claim 12, wherein
the boiled rice is disposed on the plate in such a state that the boiled rice is put inside a mold which has a through hole extending from an upper end to a lower end.

15. The method of cooling the food as claimed in claim 11, wherein
the plate having the ventilation is a punch plate which is formed with a hole having a diameter smaller than or equal to 3 mm.

16. The method of cooling the food as claimed in claim 13, wherein
the boiled molded rice is cooled to a temperature in a range from 18° C. to 25° C. after the cooling step.

17. A method of cooling a food, comprising the following steps:
i) putting the food on a plate having a ventilation;
ii) passing an air in the food, by:
insufflating the air from a nozzle to an upper part of the food and
absorbing the air with a vacuum device disposed below the plate; and
iii) cooling the food from an inner part thereof.

18. The method of cooling the food as claimed in claim 17, wherein
the nozzle has a head end formed with a port, the head end of the nozzle being sunk in the food.

19. The method of cooling the food as claimed in claim 17, wherein
the plate having the ventilation is a punch plate which is formed with a hole having a diameter smaller than or equal to 3 mm.

20. The method of cooling the food as claimed in claim 19, wherein
the hole which is disposed outermost in the punch plate defines an outer periphery that is farthest from a center of the punch plate, and
the farthest outer periphery of the outermost hole is disposed inside the outer periphery of the food by smaller than or equal to 5 mm.
